(19) United States
(12) Patent Application Publication
(10) Pub. No.: US 2010/0326137 A1
(43) Pub. Date: Dec. 30, 2010

(54) LOW NOX GLASS FURNACE WITH HIGH HEAT TRANSFER

(75) Inventors: Patrice Rouchy, Vaucresson (FR); Paul Netter, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/865,935

(22) PCT Filed: Feb. 2, 2009
(86) PCT No.: PCT/FR2009/050150

§ 371 Date: Aug. 6, 2010

(30) Foreign Application Priority Data
Feb. 8, 2008 (FR) 0850814

(51) Int. Cl. C03B 5/235

(52) U.S. Cl. 65/134.4

(57) ABSTRACT

A method of heating molten glass using a furnace including side walls including transverse burners and fitted with regenerators. At least one transverse burner is supplied with oxidant including less than 30 vol % oxygen and with fuel such that the ratio of the impulse of the oxidant to the impulse of the fuel ranges from 5 to 13. This method of operation provides excellent heat transfer to the glass and creates little pollution.

The invention relates to a glass furnace with transverse burners which is equipped with regenerators such as those used to produce the molten glass that is converted into flat glass in a float glass unit in which the glass is floated on a bath of metal, generally based on tin.

Most fuel-heated glass furnaces are faced with the problems of undesirable emissions of oxides of nitrogen (NOx) in the combustion flue gases. In addition, they need to emit as little carbon monoxide as possible and to operate effectively. The furnace operates effectively if there is high productivity (a high load) of a good-quality glass and a long life combined with the least possible energy consumption. The life of the furnace may be adversely affected by damage to the refractory linings, particularly as a result of local overheating, it being possible for said damage also to lead to the contamination of the glass produced. What happens is that local overheating may cause the refractory lining to melt and molten runs may become mixed in with the glass producing what those skilled in the art know by the English-language expression of “knots” in the glass.

NOx has a detrimental effect both on humans and on the environment; firstly, NO₂ is an irritant gas that causes respiratory diseases. Secondly, on contact with the atmosphere, it may gradually form acid rain. Finally it causes photochemical pollution because, when combined with volatile organic compounds and solar radiation, NOx causes what is known as the tropospheric ozone to form and an increase in the low-altitude concentration of this gas becomes harmful to humans, particularly during periods of intense heat. This is why the current standards on the emission of NOx are becoming increasingly tight. Because of the very existence of these standards, manufacturers and operators of furnaces, such as manufacturers and operators of glass furnaces, are constantly preoccupied with minimizing NOx emissions, preferably with limiting them to a level of below 800 or even of below 700 mg per Nm³ flue gases.

Temperature has an influence on NOx formation. Specifically, at above 1300° C., the emission of NOx increases exponentially. There are a number of techniques that have already been proposed in an attempt to reduce NOx emissions.

A first technique is to use a reducing agent on the emitted gases so as to convert the NOx into nitrogen. This reducing agent may be ammonia but that leads to disadvantages such as the difficulty of storing and handling such a product. It is also possible to use a natural gas as a reducing agent, but that is done at the expense of furnace fuel consumption and increases CO₂ emissions. The presence of reducing gases (carbon monoxide) in certain parts of the furnace such as the regenerators may also cause accelerated corrosion of the refractory linings of these zones.

It is therefore preferable to dispense with that technique by adopting what are known as primary measures. These measures are so called because the objective is not to destroy NOx that has already been formed, as in the abovementioned technique, but rather to prevent the NOx from forming, for example at the flame. These measures are also simpler to implement and therefore more economical. They may, however, not provide a full substitute for the aforementioned technique but advantageously supplement it. These primary measures are, in any event, an essential prerequisite to reducing the reagent consumption of the secondary measures.

The existing measures can be classified nonlimitingly into a number of categories:
a first category is to reduce the formation of NOx using the technique of “reburning” whereby an air-deficient zone is created at the combustion chamber of a furnace. This technique has the disadvantage of increasing the temperature at the regenerator stacks and, as appropriate, of requiring a special design of regenerators and regenerator stacks, particularly in terms of sealing and corrosion resistance. In addition, this technique produces an increase in the formation of carbon monoxide, which damages the refractory lining because of its reducing capacity;
a second category is to act on the flame, reducing or even eliminating the formation of NOx there. To do that, it is possible for example to seek to reduce the excess combustion air. It is also possible to seek to limit temperature spikes, by maintaining flame length, and to increase the volume of the flame front in order to reduce the mean temperature within the flame. A solution such as this is, for example, described in U.S. Pat. No. 6,047,565 and WO9802386. It consists in a method of combustion for melting the glass in which the fuel supply and the oxidant supply are both performed such as to spread fuel/oxidant contact over time and/or as to increase the volume of this contact with a view to reducing NOx emissions.

EP921349 (or U.S. Pat. No. 6,244,524) and French patent application No. 0754028 filed on Mar. 26, 2007 have proposed, with a view to reducing NOx, a burner equipped with at least one injector, comprising a supply pipe for liquid fuel, of the fuel oil type, and a supply pipe for atomization fluid, this pipe being positioned concentrically with respect to said liquid fuel supply pipe, said liquid fuel supply pipe comprising an element pierced with oblique passages to bring the liquid fuel into the form of a hollow jet that substantially hugs the internal wall.

JP-A-2003269709 discloses a method of heating molten glass in a furnace with transverse burners which is equipped with regenerators and runs on a gaseous fuel.

U.S. Pat. No. 4,946,382 discloses a method for burning a liquid fuel with an oxidant which may be oxygen-enriched air, in which method the ratio of the impulse of the oxygen to the impulse of the fuel is from 10 to 30.

The invention is aimed at glass furnaces equipped with transverse burners and with regenerators. To a person skilled in the art, in the context of a furnace with transverse burners, the term “burner” denotes the pair of injector/air inlet sets that face one another in the side walls, also known as breast walls. A burner therefore comprises two injectors and two air inlets, but each side wall is equipped with one of the injectors and with one of the air inlets, which are combined to generate a flame leading from one of the side walls. Each side wall is, so to speak, equipped with a half-burner of the burner, the two half-burners being placed facing each other in the side walls. Of course, an injector of a half-burner may be split into several grouped-together jets contributing to the same flame, which means that the term “injector” encompasses the idea of groups of injectors or of groups of supply pipes.

It is an object of the invention to contribute to reducing NOx by altering the way in which oxidant and fuel are introduced and, more specifically, by altering the impulse thereof. Thus, the invention relates to a method of heating molten glass using a furnace comprising side walls equipped with transverse burners and fitted with regenerators, characterized in that at least one transverse burner is supplied with oxidant comprising less than 30 vol % oxygen and with fuel such that the ratio of the impulse of the oxidant to the impulse of the fuel ranges from 5 to 13. It has in fact been found that the ratio R of the impulse of the oxidant to the impulse of the fuel was advantageously chosen from 5 to 13. As a preference, R is greater than 6. As a preference, R is less than 11 and even less than 9.5. In particular, R may range from 6 to 11 and even from 6 to 9.5.

The oxidant is always in excess in the context of the combustion reaction. The flames generated are oxidizing flames. Let it be remembered that the impulse of a substance is the product of the mass flow rate of this substance multiplied by its velocity and is expressed in Newtons. It has in fact been observed that for the same heating power, this ratio R had a considerable effect on the shape of the flame, the path of the flue gases, the temperatures in the crown of the furnace and in the upper part of the regenerator overhanging the stacks of refractory lining, known in English as the “free space” of the regenerators and on the quality of the transfer of heat to the glass. Through a sensible choice of this ratio R it has in fact been possible to observe that the combustion flue gases could return toward the burner under the crown of the furnace pressing the flame down onto the glass. This pressing of the flame onto the surface of the glass improves the transfer of heat from the flame to the glass. In addition, because of this maximum transfer of heat to the glass, the crown temperature remains reasonable because the combustion flue gases have been stripped of the greatest amount of heat energy. When R is too low, the flame is less well pressed onto the surface of the glass. The combustion flue gases also form a circulating loop under the crown, which is smaller, but the crown temperature has a tendency to be higher. When R is too high, the flame is pressed well against the glass but is in fact too long and its end has a tendency to lick the side wall (known in English as the “breast wall”) facing the injector from which the frame originates, thus leading to damage to said breast wall and causing refractory lining material to run into the bath of glass producing defects known as “knots” in the end glass. If R is particularly too high then the end of the flame may even enter the regenerator pipe opposite the ejector from which the flame originated. The effect of this is poorer heat transfer to the glass, accelerated corrosion of the regenerator pipe and of the regenerator itself, and an increase in the carbon monoxide content.

In the context of the present invention, the oxidant is air or slightly oxygen-enriched air such that the total oxygen content in the oxidant is less than 30 vol % and generally less than 25 vol %. This total oxygen content in the oxidant is greater than 15 vol %.

The oxidant is preheated before it leaves its supply pipe. Its temperature is in excess of 1200° C. It is generally lower than 1500° C.

In the context of the present invention, the fuel may be liquid. It may be a liquid fossil fuel commonly used in combustion devices for heating vitrifiable substances in a glass furnace. It may, for example, be fuel oil. In this case, an atomization fluid (such as air or natural gas) is used to atomize said liquid fuel. The atomization of the liquid fuel in the furnace is done by an injector. A particularly suitable injector has been described in French patent application No. 0754028 filed on Mar. 26, 2007 the content of which is incorporated into the present application by reference. In particular, the liquid fuel atomization injector may comprise a liquid fuel supply pipe and an atomization fluid supply pipe, said liquid fuel supply pipe comprising an element pierced with oblique passages to bring said fuel into the form of a rotating hollow jet before it is ejected from said injector, the generatrix of each of said passages forming an angle of less than 10° with the direction in which the liquid fuel is supplied. The liquid fuel is generally injected at a temperature ranging between 100 and 150° C., more preferably still between 120 and 140° C. The liquid fuel generally has a viscosity of at least 5.10⁻⁶ m²/s, particularly of between 10⁻⁵ and 2.10⁻⁵ m²/s. The fuel may also be a gas such as natural gas, methane, butane-enriched air, propane-enriched air. In this case, the injector may be of the gas double impulse type, that is to say of the type comprising two concentric fuel gas inlets, a high-pressure inlet and a low-pressure inlet, as described, for example, in French patent application No. 0850701 filed on Feb. 5, 2008 and the content of which is incorporated by reference. It may also be hybrid, that is to say may comprise a fuel gas inlet and a liquid fuel inlet, these two fuels being injected alternately or simultaneously. A hybrid injector has been described in the French patent application published under the number FR2834774.

In general, the injector is placed under the oxidant inlet. The oxidant inlet is in the form of an opening of relatively large cross section, the area of which may in particular range between 0.5 and 2 m² at each side wall (and therefore per ½ burner), it being possible for several injectors to be associated with each air inlet (the idea of a group of injectors) of each ½ burner. The oxidant supply pipe has a crown inclined downward (in the direction of flow of the oxidant) so that the oxidant adopts a direction oriented toward the surface of the bath of glass. The crown of the oxidant supply pipe makes, with the horizontal, an angle ranging from 18 to 30°. The fuel supply pipe is generally oriented slightly upward (in the direction of flow of the fuel). It makes with the horizontal an angle generally ranging from 3 to 12°.

Thus, the directions imparted to the fuel and to the oxidant are convergent at the point where the fuel and oxidant leave their respective supply pipes. The angle formed between the direction of the crown of the oxidant supply pipe and the direction of the fuel supply pipe generally ranges between 21 and 42°.

The fuel supply pipe has a far smaller cross section than the oxidant supply pipe. In the case of a liquid fuel, this cross section generally ranges between 5 and 30 mm², it being understood that this cross section may correspond to that of a single pipe or to that of a group of juxtaposed pipes in the context of one of the same ½ burners of one side wall. In the case of a gaseous fuel, this cross section generally ranges between 3000 and 9000 mm², it being understood that this cross section may correspond to that of a single pipe or to that of a group of juxtaposed pipes of one and the same ½ burner of one side wall. The ratio of the oxidant inlet cross section to the fuel inlet cross section (there may be several fuel inlets, particularly 3 to 5 inlets, in the form of a number of injectors in the same group contributing to the same flame) generally ranges from 20 to 2.10⁵.

Each transverse burner of the furnace generally has a power ranging from 4 to 12 megawatts.

The regenerators, which are well known to those skilled in the art, are used to recuperate the heat from the combustion flue gases. They consist of refractory elements placed in separate compartments operating alternately. These furnaces are generally equipped with at least three burners (each comprising two half-burners positioned facing one another and operating one after the other) and as many regenerators as there are ½ burners in order alternately to heat the oxidant and to collect the flue gases. While one ½ burner of one burner of one of the side walls is operating and producing a flame the oxidant of which is conveyed and heated by a first regenerator situated behind said burner, the flue gases are being collected and carried to a second regenerator which recuperates the heat therefrom, said second regenerator being positioned facing said ½ burner behind the other side wall. In a cycle, the operation of the two ½ burners of one and the same burner are reversed, stopping operation of the first ½ burner and bringing the second ½ burner into operation, the oxidant of which second ½ burner is conveyed and heated by the second regenerator (which during the previous step was collecting the flue gases). The first regenerator then is used to collect the flue gases. The furnace is therefore operated in one way for a set length of time (for example 10 to 40 minutes) then the operation of the furnace is reversed. In the case of a furnace with transverse burners, the regenerators are positioned behind the side walls of the furnace.

The present invention relates to all types of glass furnace with transverse burners, particularly for melting the glass so that it can be formed into flat glass in a float glass unit. The glass runs through the furnace from an upstream wall to a downstream wall and between two side walls (breast walls). The side walls (which are mutually parallel) equipped with the transverse burners are generally 7 to 16 meters apart. The burners are fitted to the breast walls in sets of two ½ burners positioned facing each other. The furnace generally comprises 3 to 10 transverse burners, that is to say that each breast wall generally comprises 3 to 10 injector/oxidant inlet sets (namely 6 to 20 injector/air inlet sets in total for the furnace).

The invention also relates to the use of the method according to the invention for reducing oxides of nitrogen (NOx) in the combustion flue gases of a glass furnace with regenerators.

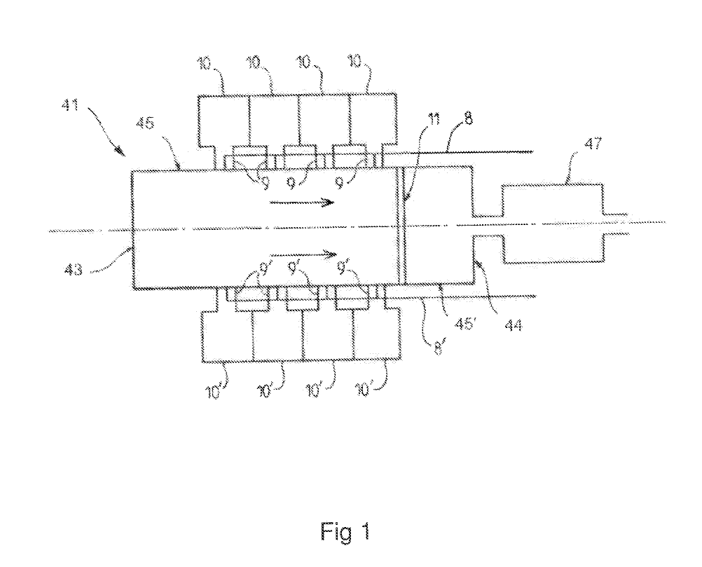

FIG. 1 depicts, viewed from above, a furnace 41 for melting glass with transverse burners and regenerators. The furnace 41 comprises an upstream wall 43, a downstream wall 44 and two side walls (or breast walls) and 45′. The vitrifiable materials are introduced close to the upstream wall 43 via a customary device that has not been depicted. The molten vitrifiable material runs from the upstream to the downstream direction as indicated by the arrows. In the case depicted, the glass passes through a cooling phase 47 for the purposes of thermal conditioning before entering the conversion unit, not depicted, and which may be a float glass installation for producing flat glass. The furnace 41 is equipped, through its two side walls, with four burners, that is to say with two rows of four aerial ½ burners operating one after the other. Each aerial ½ burner comprises an injector (or group of injectors) of fuel supplied via the ducts 8 and 8′, and a hot air inlet 9 and 9′. The injector (group of injectors) is situated under the air inlet. The openings 9 and 9′ alternately act as hot air inlet and flue gas collector. They are each connected to a regenerator 10, 10′. When the injectors of the wall 45 are in operation, those of the wall 45′ are not in operation. The flue gases pass through the openings 9′ in the side wall 45 facing them and their heat is recuperated in the regenerators 10. After a few tens of minutes the operation of the furnace is reversed, that is to say that operation of the burners in the wall is halted (the fuel gas through the duct 8 is switched off as is the flow of air through the openings 9) and the aerial ½ burners in the wall 45′ are switched on, supplying its injectors via the duct 8′ and supplying the air inlets 9′ with hot air. The air is hot because it has been heated up by the generators 10. After a few tens of minutes, the operation of the furnace is again reversed, and so on (repeating the reversal cycle). The furnace here is equipped with a submerged wall 11 but encourages the formation of conveyor belts in the molten glass.

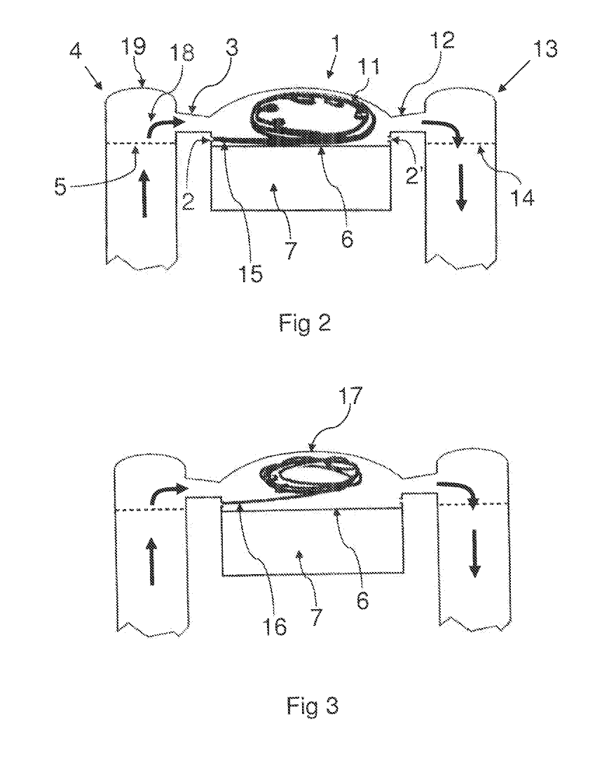

FIG. 2 depicts a furnace 1 with transverse burners, in section viewed from the side along the line of flow of the glass 7, the plane of section passing through one burner and two regenerators. The furnace is in operation. It contains a bath of molten glass 7. The injectors 2 and 2′ (only the injector 2 is in operation in FIG. 2) are positioned facing one another in the breast walls (side walls) of the furnace. A flame 15 escaping from the left-hand ½ burner, which comprises the injector 2 and the oxidant inlet 3. The oxidant is heated up after it passes through the regenerator 4 which contains the stacks of refractory lining under the dotted line 5, the part of the regenerator above this line being the free space 18 of the regenerator, said free space comprising a crown 19. The oxidant follows the path of the thick arrows in the regenerator 4 and emerges in the furnace above the injector 2. Here, the ratio R is indeed set between 5 and 13 and the flame is nicely pressed onto the surface 6 of the molten glass 7. The combustion flue gases 11 have a tendency to form a circulating loop above the flame returning toward the burner whence the flame originated. This return of flue gas pushes the flame down and advantageously presses it onto the surface of the glass. The transfer of heat to the glass is optimum. The flue gases escape through the pipe 12 of the regenerator 13 positioned facing the burner that is in operation and follow the path of thick arrows through the regenerator 13. These flue gases heat up the refractory linings of the regenerator 13 located under the dotted line 14.

FIG. 3 depicts the same glass heating device as in FIG. 2, with the same heating power, except that the ratio R is less than 5. Here, the flame 16 is not very well pressed onto the surface 6 of the glass 7. The transfer of heat energy to the glass is not as good and, as a result, the crown temperature 17 is higher.

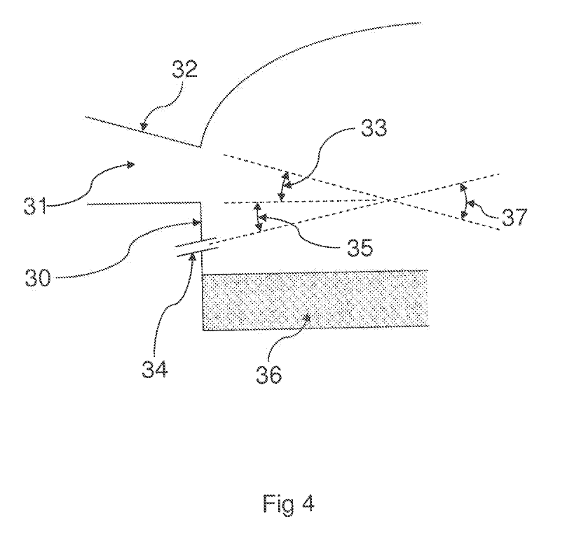

FIG. 4 illustrates the orientations imparted to the oxidant and fuel fluids in one breast wall 30 of a furnace containing a bath of molten glass 36. The oxidant emerges into the furnace via a large cross section pipe 31, the crown 32 of said pipe being directed downward and forming with the horizontal an angle 33 (18 to 30°). The fuel supply pipe 32 is of small cross section and makes with the horizontal an angle 35 (3 to 12°). Thus, the directions imparted to the fuel and to the oxidant converge at the point where the fuel and the oxidant leave their respective supply pipes. The angle 37 formed between the direction of the crown of the oxidant supply pipe and the direction of the fuel supply pipe is the sum of the angles 33 and 35 (said sum generally ranging between 21 and 42°).

### EXAMPLES 1-3

Tests were conducted on a glass furnace measuring 10.7 m×33.5 m the breast walls of which were equipped with 7 burners (14 groups of injectors, 14 air inlets and 14 regenerators). The oxidant impulse of one of the ½ burners was varied and various parameters analyzed as indicated in table 1.

All the tests were conducted at the same power, the fuel was liquid gas oil. The NOx and CO contents were measured in the free space of the regenerator collecting the flue gases.

It was found that the flame was pressed down correctly with an intermediate R in the case of example 2 which resulted in a minimum crown temperature and a collection of parameters that were excellent both in terms of glass quality and in terms of the harmfulness of the flue gases (Nox and CO).

TABLE 1
(liquid fuel oil)

| | | Ex 1 | | Ex 3 |
|---|---|---|---|---|
| | Units | (comp.) | Ex 2 | (comp.) |
| Air inlet cross | m × m | 1.7 × 0.5 | 1.7 × 0.5 | 1.5 × 0.26 |
| section | | | | |
| Air speed | m/s | 4 | 10 | 24.5 |
| Air flow rate | Nm³/h | 5830 | 5830 | 5830 |
| | kg/s | 2.09 | 2.09 | 2.09 |
| Air impulse | Newton | 8.4 | 20.9 | 51.3 |
| Fuel oil speed | m/s | 27 | 27 | 27 |
| Fuel oil flow rate | kg/h | 500 | 500 | 500 |
| | kg/s | 0.139 | 0.139 | 0.139 |
| Fuel oil impulse | Newton | 3.8 | 3.8 | 3.8 |
| R | — | 2.2 | 5.6 | 13.5 |
| Furnace crown | ° C. | 1570 | 1530 | 1570 |
| temperature | | | | |
| Regenerator crown | ° C. | >1500 | 1490 | >1500 |
| temperature | | | | |
| NOx | mg/Nm³ | 800 | 650 | 500 |
| | with 8% | | | |
| | oxygen | | | |
| CO | ppm | 200 | 200 | 1800 |
| Flame position | — | detached from | pressed | pressed onto |
| | | the glass | onto the | the glass |
| | | | glass | |
| Glass quality | — | good | good | blisters and |
| | | | | knots present |

### EXAMPLES 4-6

The procedure was as per examples 1-3 except that the fuel was natural gas injected through a gas double impulse injector. The operating conditions of one of the ½ burners were varied under the conditions compiled in table 2. All the tests were conducted at the same power. It was found that the flame was correctly pressed down with an intermediate R in the case of example 5 manifested by a minimum crown temperature (furnace and regenerator) and a set of parameters that were excellent both in terms of glass quality and harmfulness of the flue gases (NOx and CO).

TABLE 2
(natural gas)

| | | Ex 4 | | Ex 6 |
|---|---|---|---|---|
| | Units | (comp.) | Ex 5 | (comp.) |
| Air inlet cross | m × m | 1.7 × 1.25 | 1.7 × 0.5 | 1.5 × 0.28 |
| section | | | | |
| Air speed | m/s | 4.6 | 11.5 | 23.5 |
| Air flow rate | Nm³/h | 6110 | 6110 | 6110 |
| | kg/s | 2.19 | 2.19 | 2.19 |
| Air impulse | Newton | 10 | 25.2 | 51.4 |
| Gas speed | m/s | 30 | 30 | 30 |
| Gas flow rate | Nm³/h | 586 | 586 | 586 |
| | kg/s | 0.13 | 0.13 | 0.13 |
| Gas impulse | Newton | 3.81 | 3.81 | 3.81 |
| R | — | 2.6 | 6.6 | 13.5 |
| Furnace crown | ° C. | 1590 | 1570 | 1570 |
| temperature | | | | |
| Regenerator crown | ° C. | 1535 | 1510 | >1550 |
| temperature | | | | |
| | mg/Nm³ | | | |
| NOx | with 8%. | 950 | 800 | 700 |
| | oxygen | | | |
| CO | ppm | 500 | 500 | >2000 |
| Flame position | — | detached | pressed | pressed |
| | | from | onto the | onto the |
| | | the glass | glass | glass |
| Glass quality | — | acceptable | good | blisters |
| | | except for the | | and knots |
| | | localized | | present |
| | | presence of | | |
| | | large | | |
| | | bubbles | | |
| | | (usually known | | |
| | | in English | | |
| | | as “blisters” | | |

1-16. (canceled)

17. A method of heating molten glass using a furnace including side walls including transverse burners and fitted with regenerators, the method comprising:
supplying at least one transverse burner with oxidant comprising less than 30 vol % oxygen and with fuel such that the ratio of the impulse of the oxidant to the impulse of the fuel ranges from 5 to 13.

18. The method as claimed in claim 17, wherein at least one transverse burner is supplied with oxidant and with fuel such that the ratio of the impulse of the oxidant to the impulse of the fuel ranges from 6 to 11.

19. The method as claimed in claim 17, wherein the ratio of the impulse of the oxidant to the impulse of the fuel is less than 9.5.

20. The method as claimed in claim 17, wherein the oxidant comprises less than 25 vol % oxygen.

21. The method as claimed in claim 17, wherein a crown of an oxidant supply pipe makes, with the horizontal, an angle ranging from 18 to 30°.

22. The method as claimed claim 17, wherein an angle formed between a direction of a crown of an oxidant supply pipe and a direction of a fuel supply pipe ranges between 21 and 42°.

23. The method as claimed in claim 17, wherein the ratio of an oxidant inlet cross section to a fuel inlet cross section of the burner ranges from 20 to 2·10⁵.

24. The method as claimed in claim 17, wherein oxidant inlets to the transverse burner have a cross section ranging between 0.5 and 2 m2 in each side wall.

25. The method as claimed in claim 17, wherein the transverse burner has a power ranging from 4 to 12 megawatts.

26. The method as claimed in claim 17, wherein the side walls including the transverse burners are 7 to 16 meters apart.

27. The method as claimed in claim 17, wherein the furnace comprises 3 to 10 transverse burners.

28. The method as claimed in claim 17, wherein total oxygen content in the oxidant is greater than 15 vol %.

29. The method as claimed in claim 17, wherein the burner is supplied with liquid fuel.

30. The method as claimed in claim 29, wherein the burner includes an injector that atomizes the liquid fuel, including the liquid fuel supply pipe and an atomization fluid supply pipe, the liquid fuel supply pipe including an element pierced with oblique passages to bring the fuel into a form of a rotating hollow jet before it is ejected from the injector, the generatrix of each of the passages forming an angle of less than 10° with the direction in which the liquid fuel is supplied.

31. The method as claimed in claim 17, wherein the burner is supplied with gaseous fuel.

32. The use of the method of claim 17 to reduce NOx in combustion flue gases of a glass furnace with regenerators.
